(19) United States
(12) Patent Application Publication
(10) Pub. No.: US 2009/0172420 A1
(43) Pub. Date: Jul. 2, 2009

(54) TAMPER RESISTANT METHOD AND APPARATUS FOR A STORAGE DEVICE

(75) Inventor: Fernando A. Zayas, Loveland, CO (US)

Correspondence Address: SCHWEGMAN, LUNDBERG & WOESSNER, P.A., P.O. BOX 2938, MINNEAPOLIS, MN, 55402, US

(73) Assignee: KABUSHIKI KAISHA TOSHIBA, TOKYO (JP)

(21) Appl. No.: 11/967,970

(22) Filed: Dec. 31, 2007

(51) Int. Cl. G06F 12/14; H04L 9/30

(52) U.S. Cl. 713/194; 380/30

(57) ABSTRACT

A method for authenticating software for use in a device includes encrypting software to be input to a device with a private key, and decrypting the software presented to the device with a public key retrieved from a memory accessible by the device.

### TECHNICAL FIELD

Various embodiments described herein relate to apparatus, systems, and methods associated with making a storage device more tamper resistant.

### BACKGROUND

A disk drive is an information storage device. A disk drive includes one or more disks clamped to a rotating spindle, and at least one head for reading information representing data from and/or writing data to the surfaces of each disk. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor. Storing data includes writing information representing data to portions of tracks on a disk. Data retrieval includes reading the information representing data from the portion of the track on which the information representing data was stored.

Disk drive information storage devices employ a control system for controlling all aspects of the operation of the disk drive. The control system controls everything from the position of the transducing head during read operations, write operations and seeks, to receiving commands from a host computer, sending data to the host and indicating when commands are complete. The control system includes a servo control system or servo loop which is used to correctly position a transducing head for reading and writing of data. The control system may include several dedicated controllers which carry out specified functions of the disk drive.

Over time, integrated circuits have become smaller and smaller and increasingly complex. As technology marches on, more and more individual gates can be placed in one integrated circuit. In addition, more of the control functions can be placed inside an integrated circuit. Current technology integrated circuits may replace several integrated circuits of yesteryear. As electronic parts became more complex, different methods of testing were needed to assure that the parts produced were good. One method of testing electronic parts includes the use of boundary scans. Joint Test Action Group (JTAG) is a boundary scan standard, found at IEEE/ANSI 1149.1-1990, which is a collection of design rules applied principally at the integrated circuit level. The JTAG standard is entitled Standard Test Access Port and Boundary-Scan Architecture for test access ports used for testing printed circuit boards using boundary scan.

JTAG was an industry group formed in 1985 to develop a method to test populated circuit boards after manufacture. At the time, multi-layer boards and non-lead-frame ICs were becoming standard and making connections between ICs not available to probes. The majority of manufacturing and field faults in circuit boards were due to solder joints on the boards, imperfections in board connections, or the bonds and bond wires from IC pads to pin lead frames. JTAG was meant to provide a pins-out view from one IC pad to another so all these faults could be discovered. The industry standard finally became an IEEE standard in 1990 as IEEE Std. 1149.1-1990 after many years of initial use. Processors were also designed to the JTAG standard. In 1994, a supplement to the standard added a description of the boundary scan description language (BSDL) was added to the JTAG standard. Since then, this standard has been adopted by electronics companies all over the world. Boundary-scan is nowadays mostly synonymous with JTAG.

JTAG is now primarily used for accessing sub-blocks of integrated circuits, and is also useful as a mechanism for debugging embedded systems, providing a convenient “back door” into the system. When used as a debugging tool, an in-circuit emulator (ICE), which in turn uses JTAG as the transport mechanism, enables a programmer to access an on-chip debug module which is integrated into a processor or CPU, via the JTAG interface. The debug module enables the programmer to debug the software of an embedded system.

JTAG does have a downside. Providing a convenient “back door” for debugging of embedded systems also provides a convenient way for competitors to study the software and firmware instructions which are executed to control the various functions of the disk drive.

Some ICs also have a trace port. A trace port is another useful debugging tool since information about the operation of an embedded processor is available at high speed. It allows developers and others to trace, in mostly real time, what the processor is executing and what data is flowing to and from the processor. JTAG provides a way to look at the inner workings of an integrated circuit at selected times, such as an ASIC or system on a chip (SoC). The use of JTAG ports is slow since the investigation occurs only after halting the processor. The trace port provides the ability to watch what the processor is doing while the processor is executing commands without interfering or slowing it down.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive, according to an example embodiment described herein.

FIG. 2 is a view of a disk drive with a cover removed, according to an example embodiment described herein.

FIG. 3 shows a portion of a disk and a first servo wedge and a second servo wedge, according to an example embodiment.

FIG. 4 shows a block diagram of a device that includes firmware, according to an example embodiment.

FIG. 5 shows a schematic diagram of an integrated chip having at least one scan port, according to an example embodiment.

FIG. 6 is a flow chart of a method for authenticating software, according to an example embodiment.

FIG. 7 is a flow chart of a method of authenticating software, according to an example embodiment.

FIG. 8 is a schematic diagram of a cryptographic ROM, according to an example embodiment.

FIG. 9 is a schematic diagram of a cryptographic ROM during normal operations, according to an example embodiment.

FIG. 10 is an example block diagram of a computer system for implementing functions and controllers described in accordance with example embodiments.

The description set out herein illustrates the various embodiments of the invention and such description is not intended to be construed as limiting in any manner.

### DETAILED DESCRIPTION

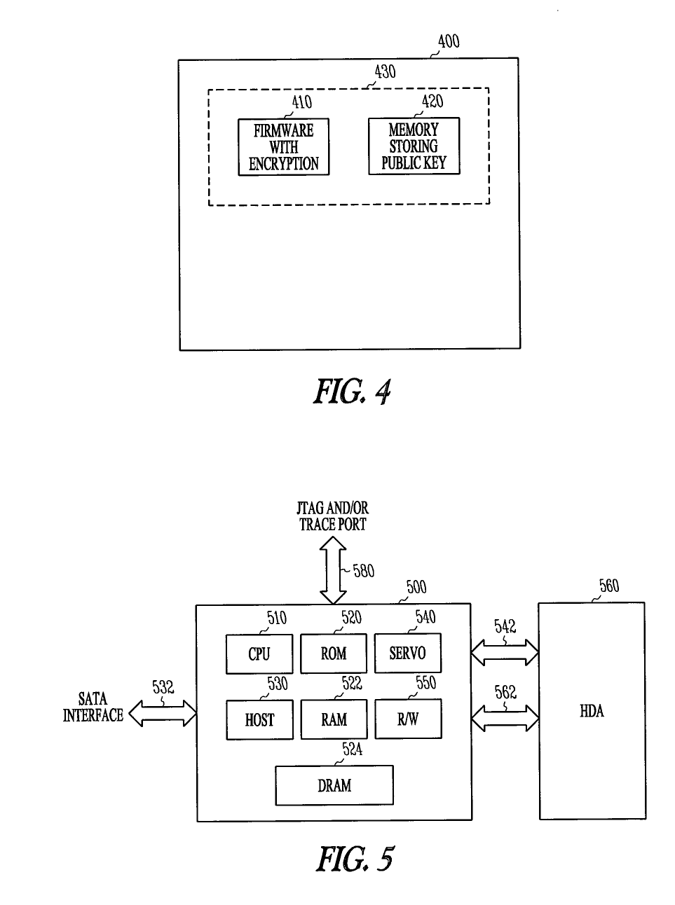

FIG. 4 is a schematic diagram of a device 400, according to an embodiment of this invention. The device 400 includes firmware 410. The firmware 410 or a portion of the firmware 410 is encrypted. The firmware 410 also may be used to generate a product which in turn is encrypted. For example, a hash of the firmware may be encrypted using a private key. The private key is kept by a manufacturer and is generally kept private or secret by the manufacturer. A public key is used to decrypt the firmware or a portion of the firmware 410. The public key is stored in a memory 420 of the device 400. In some devices, the firmware 410 and the memory 420 holding the public key are both part of an integrated circuit 430 (depicted by the dotted box).

When the device 400 starts up or when firmware is presented to the device 400, the public key is recalled from memory 420 and used to decrypt the firmware 410 or the portion of the firmware 410. If a portion of the firmware or a product, such as a hash, of the firmware is decrypted using the public key then it is compared to the firmware portion, or the firmware product, such as the hash of the firmware on the device, to determine the authenticity of the firmware. This general scheme can be used with any type of device. An example type of device that can use this type of apparatus and this method is a disk drive device, which is discussed in detail below. It should be noted that the device can be any device that uses software (also called firmware) that is used to drive or control the device or a portion of the device.

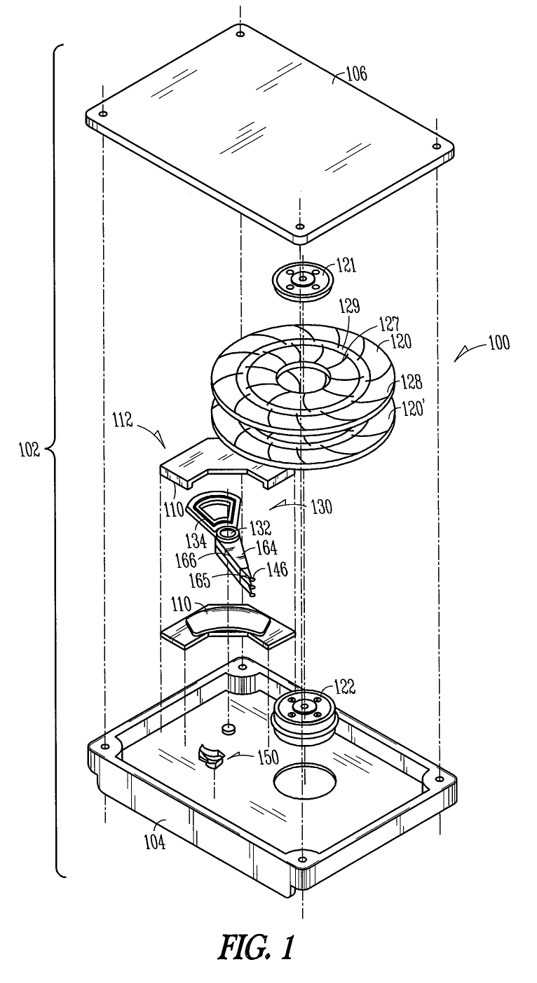

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as an MR head. It will be understood that multiple head 146 configurations can be used. The transducing head 146 is associated with a slider 165.

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the transducing head 146 over one of a plurality of tracks on the disk 120. The servo system determines an appropriate current to drive through the voice coil 134, and drives the current through the voice coil 134 using a current driver and associated circuitry (shown in FIG. 4). It should be noted that in some transducing head includes two separate elements. One element is for reading information representing data and reading positional information or servo information. This element is known as a read element. The other element, in these embodiments, is for writing information representing data and is known as a write element. One example of such a transducing head is a magnetoresistive (MR) transducing head.

Each side of a disk 120 can have an associated head 146, and the heads 146 are collectively coupled to the rotary actuator 130 such that the heads 146 pivot in unison.

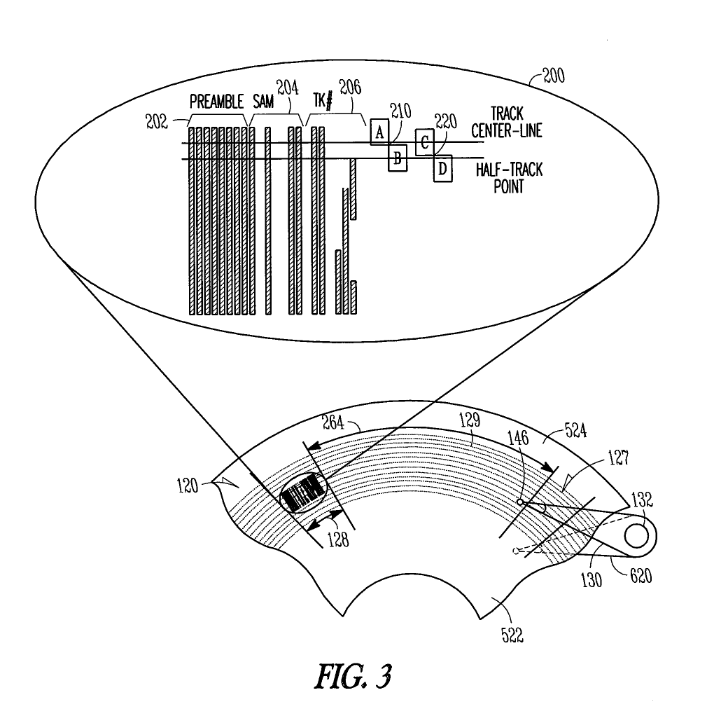

One type of servo system is an embedded, servo system in which tracks on each disk surface used to store information representing data contain small segments of servo information. The servo information, in this embodiment, is written in two sections. Each disk in a disk drive, 120, 120′ includes two surfaces on which information may be stored. One of these surfaces 520 of the disks 120, 120′ is shown in FIG. 1. The spokes on the outer diameter are represented by one spoke 128 substantially equally spaced around the outer zone of the disk 120. The spokes on the inner diameter are represented by one spoke 127 substantially equally spaced around the inner zone of the disk 120. It should be noted that in actuality there may be many more servo wedges than as shown in FIG. 1. The content of the servo wedge 128, a spoke at the outer diameter, is further detailed in FIG. 3 and in the discussions related to FIG. 3.

The disk 120 also includes a plurality of tracks on each disk surface. One of the plurality of tracks, such as track 129, is on the surface 520 of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 127, 128. The tracks on the disk 120 each include a plurality of data sectors. More specifically, a data sector is a portion of a track having a fixed block length and a fixed data storage capacity (e.g., 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo sectors 128 are typically recorded with a servo writing apparatus at the factory (called a servo-writer), but may be written (or partially written) with the disk drive's 100 transducing head 146 in a self-servo writing operation.

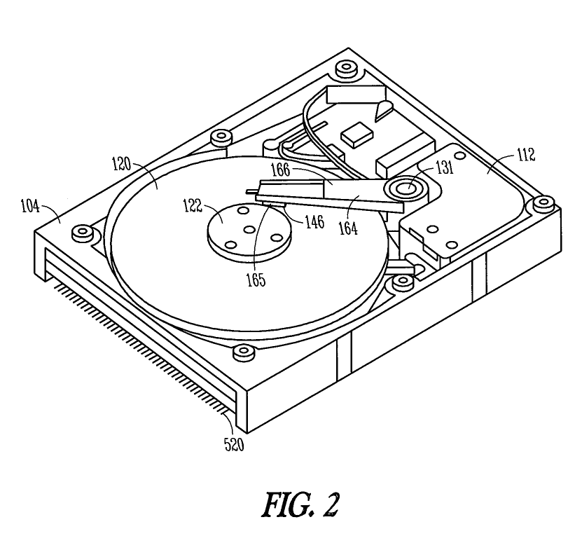

FIG. 2 is a perspective view of a substantially assembled disk drive, according to an example embodiment described herein. The housing cover 106 is removed for the sake illustration. In some embodiments, the disk drive 100 is a magnetic recording and reproducing apparatus (hard disk drive). The disk drive housing base 104 serves as a chassis. Mounted to the chassis or housing base 104 is a magnetic disk 120, a transducing head 146 including a read element and a write element. The transducing head 146 is positioned on a slider 165. The read head and the write head are formed in and at one end of the slider 165, respectively. The slider 165 is attached to the actuator by a head suspension assembly. The head suspension assembly 166 includes a suspension and an actuator arm 164 that supports the head slider 165 in transducing relation with the surface of the disk 120. Also attached to the housing base 104 or the chassis is a printed circuit board (PCB) 4200 (shown schematically in FIG. 4).

The magnetic disk 120 is a discrete track media. The magnetic disk 120 is mounted on a spindle 122 that is rotated by a spindle motor which typically is mounted within the hub or the spindle 122. Various digital data are recorded on the magnetic disk 120. In some embodiments, the data is recorded with magnetic transitions parallel to the major surface of the disk 120 while in other embodiments, the magnetic transitions are perpendicular to the major surface of the disk 120. In some embodiments, the magnetic head incorporated in the head slider 165 is a so-called integrated head including a write head of a single pole structure and a read head using a shielded MR read element (such as a GMR film or a TMR film). The voice coil motor (VCM) 112 drives the head suspension assembly about a pivot point 131 to position the magnetic head 146 at a radial position of the magnetic disk 120. The circuit board (not shown) includes an IC that generates driving signals for the voice coil motor (VCM) 112 and control signals for controlling read and write operations performed by the magnetic head 146.

FIG. 3 shows a portion of a disk 120 and at least one servo wedge 128, according to an example embodiment. FIG. 3 discusses further details related to the servo wedge 128 and shows a plurality of tracks on the surface of the disk 120. Each servo wedge 128 includes information stored as regions of magnetization. The servo wedge 128 can be longitudinally magnetized (for example, in the magnified portion of FIG. 3 a servo pattern 200 includes cross-hatched blocks magnetized to the left and white spaces magnetized to the right, or vice-versa) or alternatively perpendicularly magnetized (e.g., the cross-hatched blocks are magnetized up and the white spaces are magnetized down, or vice-versa). Servo patterns 200 contained in each servo wedge 128 are read by the transducing head 146 as the surface of the spinning disk 120 passes under the transducing head 146. The servo patterns 200 can include information identifying a data sector contained in a data field 264. For example, the servo pattern 200 can include digital information such as a preamble 202, a servo address mark (SAM) 204, a track identification number 206. The servo pattern 200 also includes a set of servo bursts. As shown in FIG. 3, the set of servo bursts include an A servo burst, a B servo burst, a C servo burst, and a D servo burst. There is a servo burst edge 210 between the A burst and the B burst, and a servo burst edge 220 between the C burst and the D burst. The pattern shown is a quadrature type pattern. In some embodiments, a disk drive will include a single column of each type of servo burst in each servo wedge 128. Each column corresponds to a radial of the disk. As shown in this embodiment, there are two columns of A, B, C, and D bursts which may be used in some embodiments. In some embodiments, the servo wedge 128 will also include other information such as a wedge number. This can be a single bit to designate an index wedge (wedge #0), or the SAM may be replaced by another pattern (referred to as a servo index mark or SIM), or the wedge may contain a few low-order bits of the wedge number or a complete wedge number. There are many different patterns for servo bursts, such as a null pattern.

This pattern shows four servo bursts and it should be understood that this may also be repeated in columns so as to produce several radial lines of AB and CD bursts on the disk in each servo wedge, such as servo wedge 128, on the disk. The servo burst pattern results in a servo burst edge 210 between the A and B servo bursts, and a servo burst edge 220 between the C and D servo bursts in the null pattern. In some embodiments, the disk 120 may be other than a magnetic disk. In such cases, the servo wedge 128 can include other indicia, such as optical indicia.

FIG. 5 shows a schematic diagram of an integrated circuit 500 for a disk drive, according to an example embodiment. The integrated circuit 500 is part of the electronics for a disk drive 100. The integrated circuit 500 can do one or more of the functions discussed with respect to FIG. 4 above as the integrated circuits become more and more capable generally an integrated circuit, such as integrated circuit 500, will do a plurality of function associated with the disk drive. In some embodiments, the integrated circuit 500 may do substantially all the functions associated with the disk drive.

As shown in FIG. 5, the integrated circuit 500 includes a central processing unit 510 as well as several types of memory. The memory aboard the integrated circuit 500 includes a read-only memory (“ROM”) 520, a random access memory (“RAM”) 522, and a dynamic random access memory (“DRAM”) 524. The integrated circuit 500 also includes a module 530 for interfacing with host computer over an interface, such as a Serial Advanced Technology Attachment (“SATA”) interface 532. The integrated circuit 500 also includes a servo module for handling the servo operation, as depicted by reference numeral 540, and a read write channel module as depicted by reference numeral 550. The integrated circuit 500 also includes an interface to the head disk assembly which is generally the actuator, transducing heads and a disk stack or a plurality of discs. The head disk assembly is depicted as reference numeral 560. The read write channel module 550 communicates with the head disk assembly 560 over a bus 562. The servo controller module 540 is operably connected to the head disk assembly 560 via the communications bus 542.

As mentioned earlier, in this embodiment the PCB includes a system on a chip (“SoC”) and a motor driver chip (“Combo Chip”). FIG. 5 shows the SoC and includes all the electronics of FIG. 4 other than the Motor driver IC. Interface 562 is the interface to the head, and more specifically, the read element and write element. Interface 562 includes the read/write path. Interface 542 is the interface to the VCM and spindle motors. In one embodiment, elements 510-520, 522 and 524 are within the MPU 430 shown in FIG. 4. The HDA is element 4100 in FIG. 4.

In addition, the integrated circuit 500 includes one or more trace ports or JTAG ports as depicted by reference numeral 580. Each one of the interfaces, shown as busses 532, 562, 542, or the JTAG and/or trace ports 580 can have inputs to the integrated circuit or outputs from the integrated circuit 500 as depicted by the two way arrows. Therefore, the integrated circuit 500 has any number of output ports as depicted by the output portion of the two way arrows and a plurality of input ports as depicted by the inbound portion of the two way arrows 532, 542, 562, and the two way arrow 580. It should be noted that the trace port portion of port 580 is output only.

In one embodiment, the integrated circuit 500 is an application-specific integrated circuit (ASIC) which is an integrated circuit (IC) customized for a particular use, rather than intended for general-purpose use. It should be noted that the integrated circuit 500 may be any type of integrated circuit. It can be a controller dedicated to handle one function of the disk drive. For example, the integrated circuit can be a controller for handling substantially all the servo information. In another example, the integrated circuit 500 can be a dedicated controller for handling a read and write channel. In still another embodiment, the integrated circuit 500 may handle error detection and correction. In still another embodiment, the integrated circuit may handle a plurality of functions of the disk drive 100. Furthermore, it can be the “System on a Chip” ASIC for any device or appliance that needs to hide information from the visibility ports 580 (such as JTAG ports or trace ports). In other words, the integrated circuit can be used in any number or type of device and is not limited to a disk drive device. The embodiments discussed herein are equally applicable to many types of integrated circuits.

In some embodiments the DRAM 524 internal to the IC 500 can be replaced by external DRAM. A bus would connect the IC 500 and the external DRAM.

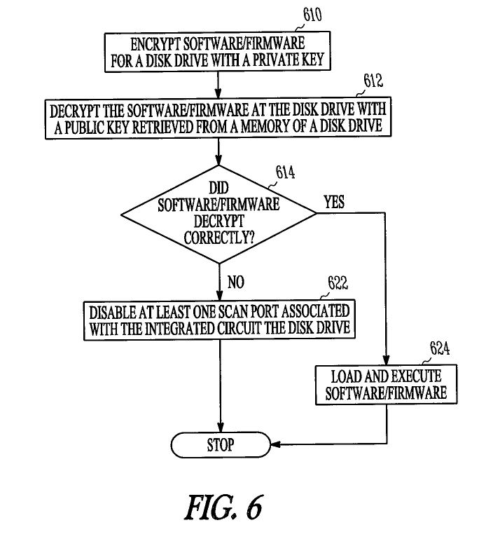

FIG. 6 is a flow chart of a method 600 for authenticating software, such as firmware, according to an example embodiment. The term software also covers firmware resident on a device such as a disk drive. The method 600 for authenticating software for use in a disk drive includes encrypting software to be input to a disk drive with a private key 610, and decrypting the software at the disk drive with a public key retrieved from a memory of a disk drive 612. The public key used to decrypt the software/firmware comes from ROM 520 (shown in FIG. 5). The public key is used to decrypt the software/firmware.

The software/firmware is encrypted with a private key. The private key is not used again. At power-on time of the device, the manufacturer and the hard drive, a ROM resident in the SoC (ASIC) decrypts the firmware using a public key resident within the device or hard drive. This key does not need to be hidden. If the firmware decrypts correctly, then the firmware is allowed to execute.

FIG. 7 is a flow chart of a method 800 of authenticating software, according to an example embodiment. The method 800 includes computing a hash of the firmware to be loaded or executed as depicted by reference numeral 810. Next the encrypted hash that is supplied with the firmware is located and decrypted by reference numeral 812. Next it is determined whether or not the hashes match as depicted by decision box 814. If the hashes match, then the firmware is loaded and run as depicted by reference numeral 816. If the hashes do not match, the provided firmware is not run. In one embodiment of the invention the process enters an infinite loop as depicted by 818 so that the person that attempted to load the unauthorized firmware essentially renders the hardware useless.

This method is more quickly implemented at startup of the device. Rather than encrypting the entire firmware image with a private key known only to manufacturer or source of the firmware, only encrypt the hash of the firmware is encrypted. This saves time during the manufacture and at each startup of the device. The ROM in the HDD that “boots” the firmware (runs at power on) then computes the hash of the firmware. This hash value is compared to the encrypted hash decrypted with a public key. The public key is stored in the ROM or other memory of the device. Since the amount of data or firmware to be decrypted is small, this is faster than the option in which all the firmware is encrypted.

Some ROMs are hardwired and cannot be changed. Other ROMs may be electrically erasable (e.g., FLASH ROM) and can be erased and reprogrammed. For purposes of the embodiment being currently discussed, the ROM is truly “read only”. The ROM contains the first software or code to run after power on. The code associated with the ROM has the task of loading the firmware from another place, for example, from an external, serial Flash, and into processor executable memory, such as RAM internal to the ASIC or external to the ASIC. This process is similar to booting up a computer system. The first ROM is, therefore, not disk specific. Instead it is just a “loader” for the disk specific firmware that is placed in, for example, the external Flash.

A first line of defense to prevent anything but firmware produced by a known entity being executed is to sign the firmware with a private key. The boot ROM, that cannot be changed, confirms the signature with its matching public key. In another embodiment, the entire firmware image could be encrypted and then the boot ROM could decrypt the firmware and check it.

In other implementations, for example, if the flash ROM is directly executable and need not be copied or loaded, the boot ROM checks the legitimacy of the flash ROM contents. This can be done by checking a signature of the flash contents. As long as some non-changeable piece of code, such as the boot ROM, gets to run first that checks or decrypts the changeable firmware, the source of the firmware can be determined with reasonable certainty. Of course, if the key used to sign the firmware is compromised, then the source of the software is compromised.

All of this assumes that the firmware was signed (the hash of the firmware was encrypted by a private key known only to the originating party) and that the boot ROM has the matching key to check the signature (decrypt the hash using a matching public key so it can compare it to the just computed hash.)

When a hard drive interacts with a host to form a trusted relationship to do trusted work, the host will request the hard drive to encrypt/decrypt or sign messages. Some of these encryptions/decryptions involve public/private keys. It is important to keep private keys private. If private keys are obtained by another party, the other party could impersonate the original party. It should be noted that this is not limited to disk drives but can be applicable to when any appliance interacts with another appliance to form a trusted relationship.

Certain ICs, such as the SoC, have visibility ports (e.g., JTAG, trace) for debug. When doing cryptographic work it is desirable to turn off or disable the visibility ports (e.g., JTAG, trace) thereby hiding the cryptographic work. In addition, when not doing cryptographic work, it is desirable that the memory that holds certain secrets, such as keys or selected algorithms or the like, is not visible to the processor.

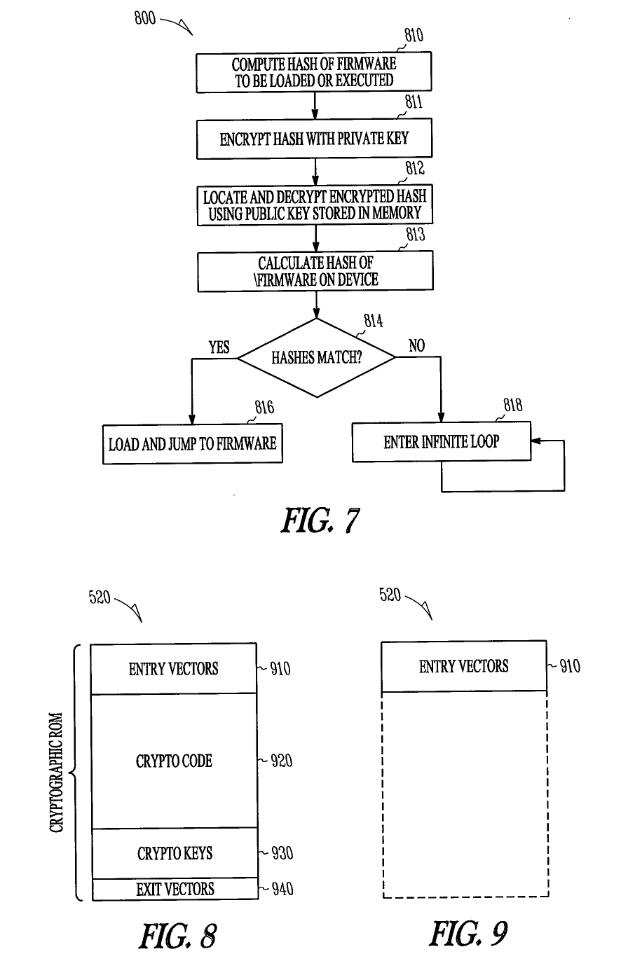

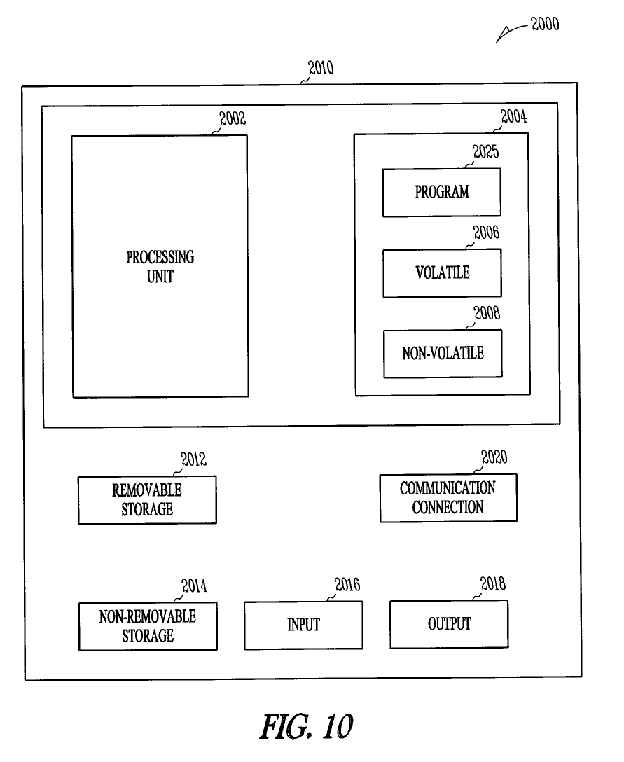

FIGS. 8 and 9 are schematic diagrams of a ROM 520, or a portion of ROM 520, that includes cryptographic data or information, according to an example embodiment. FIG. 9 shows the cryptographic ROM in a first state where the entire ROM 900 is visible to the processor and the visibility ports are disabled. FIG. 10 shows the cryptographic ROM 900 in a second state where only the entry vectors are visible to the processor and visibility ports are enabled. The second state, shown in FIG. 10, is generally used during normal operation of the device or normal operation of the ROM and the microprocessor which accesses it. As shown in FIG. 9 the cryptographic ROM 900 includes a section of data called entry vectors 910, a section of data termed crypto code 920, another section of crypto keys 930, and a final section of exit vectors 940.

The entry vectors 910 are branch instructions that jump into the middle of the block called crypto code 920. Each entry vector 910 corresponds to a function that does some action (such as encrypt or decrypt or sign). Hardware detects that the processor 510 (see FIG. 5) is executing an instruction in the entry vectors 910 range of addresses and disables the visibility ports 580 (see FIG. 5), (JTAG, trace), disables breakpoints, and enables the rest of the cryptographic ROM 900 to be visible to the processor. Any piece of firmware can request something be encrypted or signed or decrypted, but while this request is being executed (until we exit via one of the exit vectors (there may be only one), the operations of the embedded processor 510 is masked by disabling the visibility ports, such as the JTAG and/or Trace port 580 (see FIG. 5). The length of time for masking is until exiting via an exit vector 940. Furthermore, the execution can not be halted at a breakpoint since the breakpoints are also disabled for this term. Once the function in the cryptographic ROM is done, it leaves (returns to its caller) via one of the exit vectors. Hardware detects that the processor is executing an instruction in the exit vectors 940 range of addresses and causes the visibility ports 580 to be enabled and causes the bulk of the cryptographic ROM 900 to disappear to the processor 510. An intruder can again peek and poke using JTAG and can trace the execution of the processor 510, a portion of the cryptographic portion of the ROM 900 is not there to look at.

A method for authenticating software for use in a device includes encrypting software to be input to a disk drive with a private key, and decrypting the software with a public key retrieved from a memory accessible to the device. The method includes executing the software presented to the device when it matches the decryption of the previously encrypted software. The method also includes determining that the software decrypted with the public key of the software does not match the software for running on of the device, and disallowing the execution of the software. In some embodiments, the method of claim 1 further includes determining that the software decrypted with the public key of the software does not match the software for running on of the device, and disabling at least one scan port associated with an integrated circuit associated with the device. In other embodiments, the method includes determining that the software decrypted with the public key of the software does not match the software for running on of the device, and disabling substantially every scan port associated with an integrated circuit associated with the device. In still other embodiments of the method the decrypted software is compared to the software presented to the device, and is loaded for execution when the decrypted software matches the encrypted software. In one embodiment, the software is firmware that includes a set of instructions to be embedded in a hardware element associated with the device. In still other embodiments, the device is a disk drive.

A method includes determining a hash code on firmware used to operate a device, encrypting the determined hash code using a private key, and storing a public key in a memory accessible to the device. Before execution of firmware presented to a device, the hash code of the firmware presented to the device is determined. The previously encrypted hash code of the firmware is decrypted and compared to the hash code of the firmware presented for execution on the device.

The firmware presented to the device is allowed to be loaded and executed by the device when the decrypted hash code matches the hash code of the firmware presented for execution on the device. The firmware presented to the device is prevented from being loaded and executed by the device when the decrypted hash code does not match the hash code of the firmware presented for execution on the device. In some embodiments, the device is an integrated circuit that includes one or more trace ports. The method further includes disabling at least one of the trace ports. In another embodiment, the integrated circuit further includes a JTAG port. The method further includes disabling the JTAG port. In some embodiments, the integrated circuit is an application specific integrated circuit. In still other embodiments, the integrated circuit is an application specific integrated circuit that handles a plurality of functions of a disk drive.

A disk drive 100 includes a disk 120 for storing information representing data, an actuator 130, and a transducer attached to the actuator. The disk further includes information representative of data and a servo pattern. The actuator moves the transducer over a surface of the disk, the transducer held in transducing relation to the disk. The disk drive also includes an integrated circuit for controlling at least one function of the disk drive. The integrated circuit includes a memory or has access to a memory.

A block diagram of a computer system that executes programming for performing the above methods 600, 700 is shown in FIG. 10. A general computing device in the form of a computer 2010, may include a processing unit 2002, memory 2004, removable storage 2012, and non-removable storage 2014. Memory 2004 may include volatile memory 2006 and non volatile memory 2008. Computer 2010 may include or have access to a computing environment that includes a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The microprocessor 210 or other selected circuitry or components of the disk drive may be such a computer system.

Computer-readable instructions stored on a computer-readable medium are executable by the processing unit 2002 of the computer 2010. A hard drive, CD-ROM, and RAM are some examples of articles including a computer-readable medium. A machine-readable medium provides instructions that, when executed by a machine, cause the machine to determine that software code has been presented to an input port, and enable an authentication routine to authenticate the software code. As mentioned above, the machine readable medium can include instructions to carry out either of the methods 600, 700 set forth above. For example, in implementing the method 700, the machine readable medium provides determining that software code has been presented to an input port, and enables an authentication routine to authenticate the software code. The machine readable media further include instructions that cause the machine to disable an output port when the authentication routine fails to authenticate the software code. In another embodiment, the machine readable medium provides further instructions, when executed by a machine, that cause the machine to mask an output port when the authentication routine fails to authenticate the software code. In still another embodiment, the machine readable medium provides further instructions, when executed by a machine, that cause the machine to prevent execution of the software code in when the authentication routine fails to authenticate the software code.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for authenticating software for use in a device comprising:
encrypting software to be input to a disk drive with a private key; and
decrypting the software at the device with a public key retrieved from a memory of in communication with the device.

2. The method of claim 1 further comprising executing the software presented to the device matches the decryption of the previously encrypted.

3. The method of claim 1 further comprising:
determining that the software decrypted with the public key of the software does not match the software for running on of the device; and
disallowing the execution of the software.

4. The method of claim 1 further comprising:
determining that the software decrypted with the public key of the software does not match the software for running on of the device; and
disabling at least one scan port associated with an integrated circuit associated with the device.

5. The method of claim 1 further comprising:
determining that the software decrypted with the public key of the software does not match the software for running on of the device; and
disabling substantially every scan port associated with an integrated circuit associated with the device.

6. The method of claim 1 further comprising:
comparing the decrypted software to the software presented to the device;
loading the software; and
executing the loaded software.

7. The method of claim 1 wherein the software is firmware that includes a set of instructions to be embedded in a hardware element associated with the device.

8. The method of claim 1 wherein the device is a disk drive.

9. A method comprising:
determining a hash code on firmware used to operate a device;
encrypting the determined hash code using a private key;
storing a public key in a memory accessible to the device;
and before execution of firmware presented to a device, determining the hash code on the firmware presented to the device; and
decrypting the previously encrypted hash code of the firmware; and
comparing the decrypted hash code to the hash code of the firmware presented for execution on the device.

10. The method of claim 9 wherein the firmware presented to the device is allowed to be loaded and executed by the device when the decrypted hash code matches the hash code of the firmware presented for execution on the device.

11. The method of claim 9 wherein the firmware presented to the device is prevented from being loaded and executed by the device when the decrypted hash code does not match the hash code of the firmware presented for execution on the device.

12. The method of claim 9 wherein the device is an integrated circuit.

13. The method of claim 11 wherein the device is an integrated circuit which further comprises a trace port, the method further comprising disabling the trace port.

14. The method of claim 11 wherein the integrated circuit further comprises a JTAG port, and wherein the method further comprises disabling the JTAG port.

15. The method of claim 12 wherein the integrated circuit is an application specific integrated circuit.

16. The method of claim 12 wherein the integrated circuit is an application specific integrated circuit that handles a plurality of functions of a disk drive.

17. An integrated circuit comprising:
a processor;
a read only memory communicatively coupled to the processor;
a visibility port associated with the integrated circuit capable of providing information about the processor and the read only memory to the port, wherein the read only memory includes at least a portion of cryptographic information; and
a visibility port disabler that masks visibility port during cryptographic operations of the processor.

18. The integrated circuit of claim 17 wherein the portion of the read only memory including cryptographic information includes:
an entry vector; and
an exit vector, wherein the visibility port disabler masks the visibility port between the time the entry vector is requested and the exit vector request is executed.

19. A machine-readable medium that provides instructions that, when executed by a machine, cause the machine to:
determine that software code has been presented to an input port; and
enable an authentication routine to authenticate the software code.

20. The machine readable medium of claim 19 wherein the machine readable medium provides further instructions, when executed by a machine, that cause the machine to disable an output port when the authentication routine fails to authenticate the software code.

21. The machine readable medium of claim 19 wherein the machine readable medium provides further instructions, when executed by a machine, that cause the machine to mask an output port when the authentication routine fails to authenticate the software code.

22. The machine readable medium of claim 19 wherein the machine readable medium provides further instructions, when executed by a machine, that cause the machine to prevent execution of the software code in when the authentication routine fails to authenticate the software code.
